(19) United States
(12) Patent Application Publication
(10) Pub. No.: US 2011/0120369 A1
(43) Pub. Date: May 26, 2011

(54) SHIELDING TOOL

(75) Inventor: CHEN-HSING CHENG, Tu-Cheng (TW)

(73) Assignee: HON HAI PRECISION INDUSTRY CO., LTD., Tu-Cheng (TW)

(21) Appl. No.: 12/650,855

(22) Filed: Dec. 31, 2009

(30) Foreign Application Priority Data
Nov. 26, 2009 (TW) 98140452

(51) Int. Cl. B05C 21/00

(52) U.S. Cl. 118/505; 118/504

(57) ABSTRACT

A shielding tool protects a non-sprayed surface of a workpiece including a coating surface and defining a groove in the coating surface, with a bottom surface of the groove is the non-sprayed surface of the workpiece. The shielding tool includes a first shield member positioned in the groove of the workpiece, and a second shield member positioned on the first shield member. The first shield member includes an abutting surface. The second shield member includes a resisting surface abutting the abutting surface of the first shield member. The abutting surface and the resisting surface are substantially the same shape and size as the bottom surface of the groove. A gap is formed between the abutting surface and the resisting surface.

### BACKGROUND

1. Technical Field

The present disclosure relates to a shielding tool for protecting a non-sprayed surface of a workpiece.

2. Description of Related Art

Electronic devices, such as mobile phones, computers, and media players, are often spray printed to obtain a pleasing appearance. An outer surface of the electronic device often has a plurality of sprayed areas. For example, the electronic device may define a groove in the outer surface for mounting an electronic component and sprayed with a different color coating. When spraying the electronic device, such surfaces need to be protected from spraying.

Generally, the bottom surface of the groove is shielded by a shield member of substantially the same shape and size as the groove. During spraying, the shield member is positioned in the groove.

However, the shield member cannot fit perfectly in the groove due to manufacturing tolerance, so that a gap is formed between the shield member and a side surface of the groove. During spraying, a portion of the coating sprayed on the periphery of the groove is easily absorbed by the gap due to capillary action. The excess coating can then flow to the bottom surface of the groove.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a front view of a first embodiment of a shielding tool positioned on a workpiece.

FIG. 2 is a partial, enlarged view of the shielding tool in FIG. 1.

FIG. 3 is similar to FIG. 2, but showing the shielding tool in a working state.

FIG. 4 is a partial, enlarged view of a second embodiment of a shielding tool positioned on a workpiece.

FIG. 5 is a partial, enlarged view of a third embodiment of a shielding tool positioned on a workpiece.

FIG. 6 is similar to FIG. 5, but showing the shielding tool in a working state.

### DETAILED DESCRIPTION

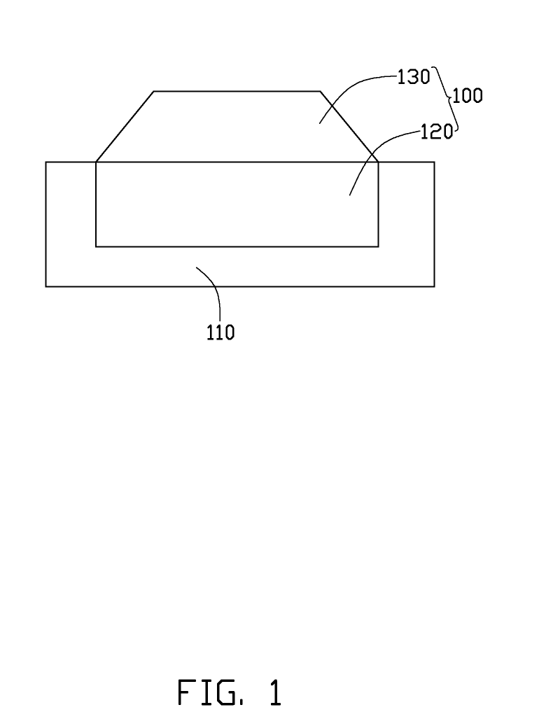

Referring to FIG. 1, a first embodiment of a shielding tool 100 to protect a non-sprayed surface of a workpiece 110 is shown. The shielding tool 100 includes a first shield member 120 and a second shield member 130 positioned on the first shield member 120.

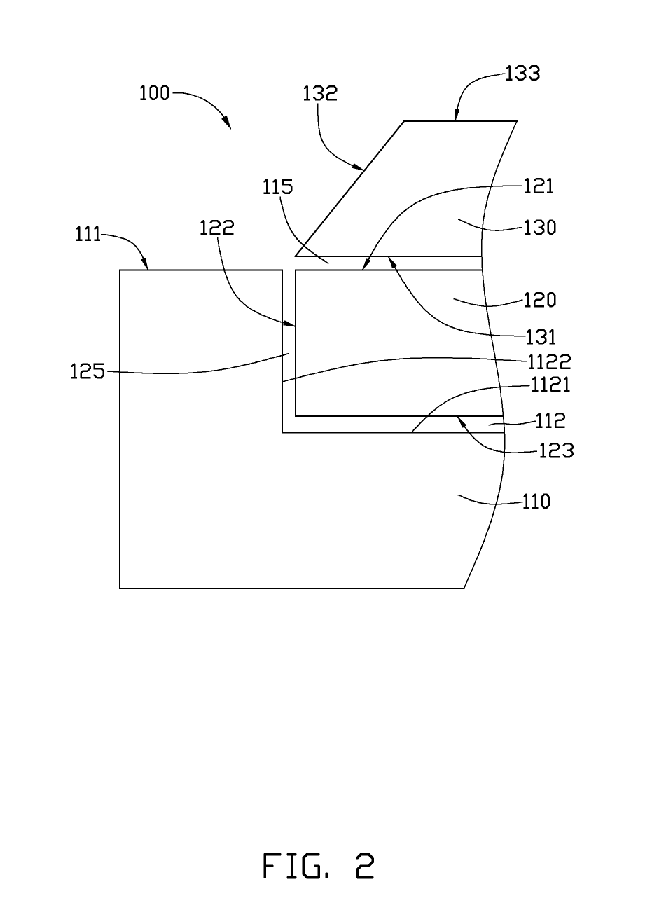

Referring to FIG. 2, the workpiece 110 includes a coating surface 111 to be sprayed and defines a groove 112 in the coating surface 111. The groove 112 is cooperatively defined by a bottom surface 1121 and a side surface 1122 extending substantially perpendicular from an edge of the bottom surface 1121. In the illustrated embodiment, the bottom surface 1121 is a non-sprayed surface.

The first shield member 120 can be substantially sheet shaped, and includes an abutting surface 121, a side surface 122 adjoining the abutting surface 121, and a shield surface 123 opposite to the abutting surface 121. The shield surface 123 and the abutting surface 121 are substantially the same shape and size as the bottom surface 1121 of the groove 112. The side surface 122 is substantially perpendicular to the abutting surface 121. In the illustrated embodiment, the abutting surface 121 is a planar surface.

The second shield member 130 can be substantially sheet shaped, and includes a resisting surface 131, a guiding surface 132 adjoining the resisting surface 131, and a top surface 133 opposite to the resisting surface 131. The resisting surface 131 is substantially the same shape and size as the abutting surface 121. In the embodiment of FIG. 2, the resisting surface 131 and the top surface 133 are both substantially planar surfaces and substantially parallel to each other. The guiding surface 132 and the resisting surface 131 cooperatively define an acute angle therebetween.

In use, the first shield member 120 is positioned in the groove 112. The shield surface 123 of the first shield member 120 abuts the bottom surface 1121 of the groove 112. The side surface 122 of the first shield member 120 abuts the side surface 1122 of the groove 112. The second shield member 130 is positioned on the first shield member 120. The resisting surface 131 of the second shield member 130 abuts the abutting surface 121 of the first shield member 120. A first gap 115 is formed between the resisting surface 131 and the abutting surface 121, and a second gap 125 is formed between the side surface 122 and the side surface 1122, due to manufacturing tolerance.

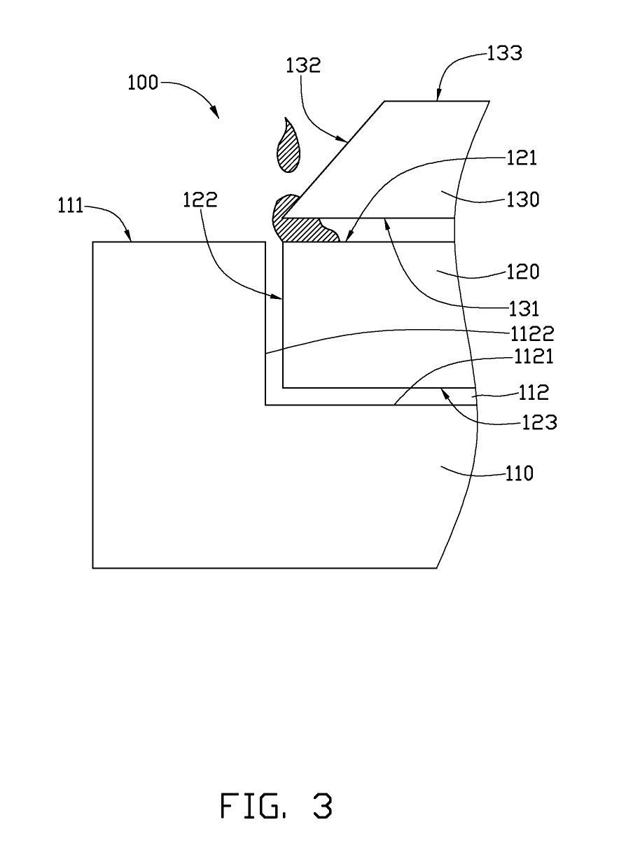

Referring to FIG. 3, during spraying, the coating may be sprayed on the periphery of the groove 112 and the second shield member 130. A portion of the coating sprayed on the periphery of the groove 112 is absorbed by the first gap 115 by capillary action. A portion of the coating sprayed on the second shield member 130 flows along the guiding surface 132, and is absorbed by the first gap 115 by capillary action. Thus, the coating absorbed by the second gap 125 is decreased and little coating reaches the bottom surface 1121 of the groove 112.

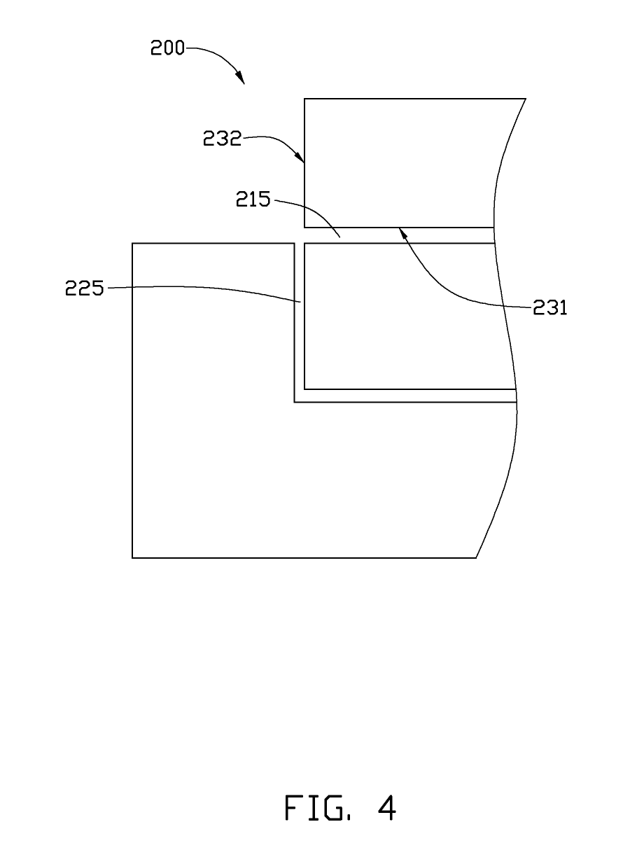

Referring to FIG. 4, a second embodiment of a shielding tool 200 is similar to the first embodiment of the shielding tool 100, differing only in that a guiding surface 232 is substantially perpendicular to a resisting surface 231 of the shielding tool 200. During use of the shielding tool 200, minimal coating is sprayed on the guiding surface 232, and is easily absorbed by a first gap 215, leaving little or no coating to be absorbed by the second gap 225.

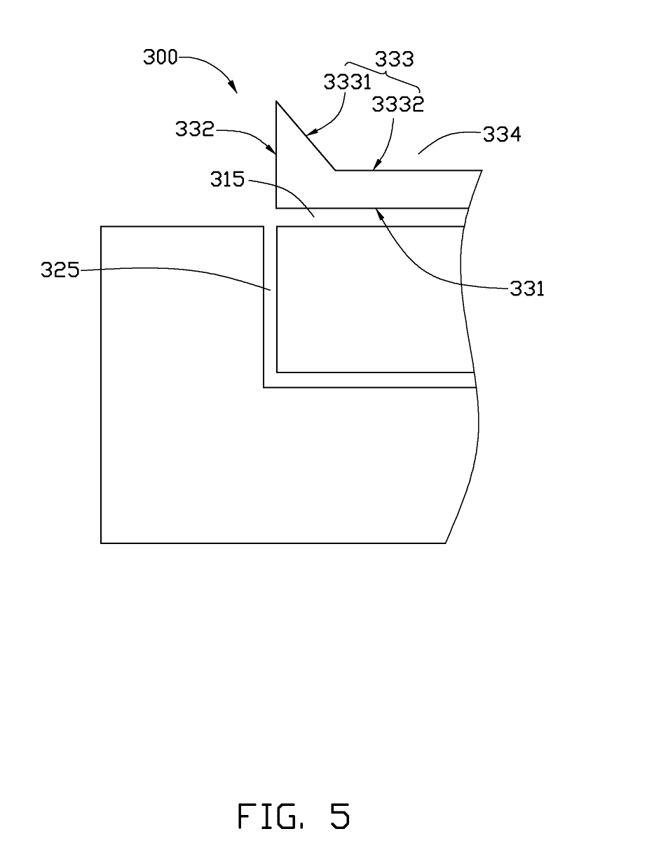

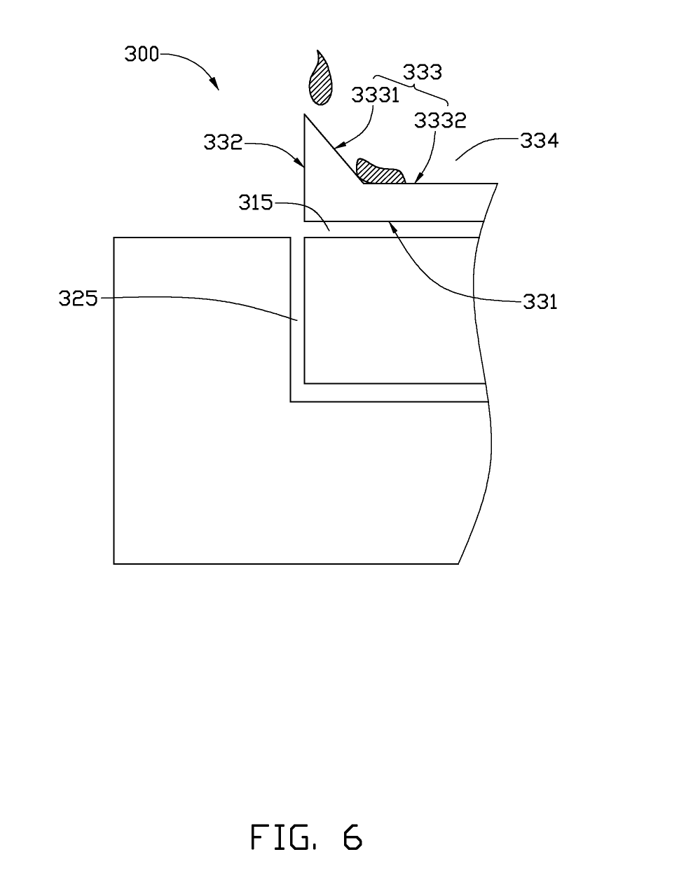

Referring to FIGS. 5 and 6, a third embodiment of a shielding tool 300 is similar to the first embodiment of the shielding tool 100, differing only in that a guiding surface 332 is substantially perpendicular to a resisting surface 331, and a top surface 333 includes an inclined surface 3331 and a planar surface 3332 adjoining the inclined surface 3331. The inclined surface 3331 and the guiding surface 332 cooperatively define an acute angle therebetween, such that the inclined surface 3331 and the planar surface 3332 cooperatively define a receiving groove 334. During use of the shielding tool 300, a coating sprayed on the top surface 333 is received in the receiving groove 334, thus little coating reaches the guiding surface 332. The small volume of coating positioned on the guiding surface 332 is easily absorbed by a first gap 315, thus the amount of the coating absorbed by a second gap 325 is minimal.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A shielding tool for protecting a non-sprayed surface of a workpiece, the workpiece comprising a coating surface and defining a groove in the coating surface, a bottom surface of the groove being the non-sprayed surface of the workpiece, the shielding tool comprising:
a first shield member for being positioned in the groove of the workpiece, the first shield member comprising an abutting surface; and
a second shield member positioned on the first shield member, the second shield member comprising a resisting surface abutting the abutting surface of the first shield member;
wherein the abutting surface and the resisting surface are substantially the same shape and size as the bottom surface of the groove, and a gap is formed between the abutting surface and the resisting surface.

2. The shielding tool of claim 1, wherein the first shield member further comprises a shield surface opposite to the abutting surface, and the shield surface abuts the bottom surface of the groove.

3. The shielding tool of claim 2, wherein the shield surface is substantially the same shape and size as the bottom surface of the groove.

4. The shielding tool of claim 1, wherein the first and the second shield members are both substantially sheet shaped.

5. The shielding tool of claim 1, wherein the abutting surface and the resisting surface are both substantially planar surfaces.

6. The shielding tool of claim 1, wherein the second shield member further comprises a guiding surface adjoining the resisting surface, and a top surface opposite to the resisting surface.

7. The shielding tool of claim 6, wherein the resisting surface and the top surface are both substantially planar surfaces and substantially parallel to each other; the guiding surface and the resisting surface cooperatively define an acute angle therebetween.

8. The shielding tool of claim 6, wherein the resisting surface and the top surface are both substantially planar surfaces and substantially parallel to each other; the guiding surface is substantially perpendicular to the resisting surface.

9. The shielding tool of claim 6, wherein the guiding surface is substantially perpendicular to the resisting surface; the top surface comprises an inclined surface and a planar surface adjoining the inclined surface; the inclined surface and the guiding surface cooperatively define an acute angle therebetween.

10. The shielding tool of claim 6, wherein the guiding surface is substantially perpendicular to the resisting surface; the top surface defines a receiving groove therein.
